(19) United States
(12) Patent Application Publication
(10) Pub. No.: US 2007/0195421 A1
(43) Pub. Date: Aug. 23, 2007

(54) Synergetically enhanced optical film and process for making same

(76) Inventor: Ching-Bin Lin, Taipei (TW)

Correspondence Address: Ching-Bin Lin, P. O. Box 55-846, Taipei, 104, TW

(21) Appl. No.: 11/358,349

(22) Filed: Feb. 22, 2006

(51) Int. Cl. G02B 27/10

(52) U.S. Cl. 359/619

(57) ABSTRACT

An optical film includes: a structured-surface layer and a supporting layer bonded with the structured-surface layer, wherein the structured-surface layer includes a plurality of upper prismatic or structured protrusions formed on an upper portion of the structured-surface layer and having a plurality of lower prismatic protrusions or lower protrusions formed on a bottom portion of the structured-surface layer. The supporting layer is recessed with a plurality of notches to be engaged with the lower protrusions of the structured-surface layer to thereby firmly interlock the structured-surface layer with the supporting layer to increase the film strength and also to increase the brightness of the optical film.

### BACKGROUND OF THE INVENTION

U.S. Pat. No. 6,846,089 disclosed an optical film having a prismatically structured surface for increasing a display brightness by bonding the structured surface to a second film using a layer of adhesive by penetrating the structured surface into the adhesive layer in order to increase the film strength and to reduce the film damage during display assembly.

However, when increasing the penetration of prism tip into the adhesive layer (namely, the thickness of the adhesive layer being increased), the on-axis brightness of the light passing the films will be reduced. Conflictingly, the thicker the adhesive layer is, the stronger strength or peel strength of the films will be.

Many factors or variables for obtaining an optimum process condition for making an optical film to satisfy both brightness and film strength should be carefully considered, including: the selection of adhesive materials, the rheology (including wicking) of the adhesive materials, the cross-linking property and the surface energy of the adhesive materials; the pressure, speed and temperature of the laminating process for making the optical films, thereby greatly increasing the production complexity and cost for making the films.

The present inventor has found the drawbacks of the prior art and invented the present optical film having its brightness, strength and related properties synergetically enhanced.

### SUMMARY OF THE INVENTION

The object of the present invention is to provide an optical film including: a structured-surface layer ad a supporting layer bonded with the structured-surface layer; with the structured-surface layer having a plurality of upper prismatic or structured protrusions formed on an upper portion of the structured-surface layer and having a plurality of lower prismatic protrusions or lower protrusions formed on a bottom portion of the structured-surface layer without forming interface between the upper and lower protrusions; each lower protrusion engaged with each notch as recessed in an upper portion of the supporting layer to thereby firmly interlock the structured-surface layer with the supporting layer to increase the film strength and also to increase the brightness of the optical film.

### BRIEF DESCRIPTION OF THE DRAWINGS

FIG. 1 shows a first preferred embodiment of the present invention.

FIG. 2 is an illustration showing a light path passing through the layers of the present invention in comparison with a conventional one (as shown in dotted line).

FIG. 3 shows a backlight module for optical simulation as provided in the present invention for testing in comparison with control tests.

FIG. 4 shows a relationship between the ratio to on-axis brightness of the examples as given in the present invention versus the viewing angles.

FIG. 5 shows an illustration of a second preferred embodiment of the present invention.

FIG. 6 shows a third preferred embodiment of the present invention.

FIG. 7 shows a fourth preferred embodiment of the present invention.

FIG. 8 shows a fifth preferred embodiment of the present invention.

FIG. 9 shows a sixth preferred embodiment of the present invention.

FIG. 10 shows a seventh preferred embodiment of the present invention.

FIG. 11 shows an eighth preferred embodiment of the present invention.

FIG. 12 shows a ninth preferred embodiment of the present invention.

FIG. 13 shows a tenth preferred embodiment of the present invention.

FIG. 14 shows the lower protrusions oriented perpendicularly to the upper protrusions of the structured-surface layer in accordance with the present invention.

### DETAILED DESCRIPTION

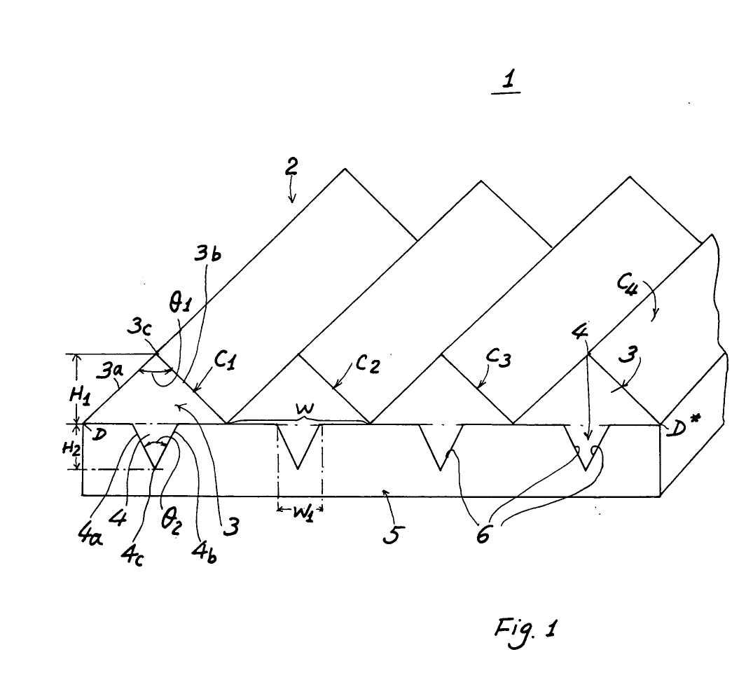

As shown in FIG. 1, an optical film 1 of a first preferred embodiment of the present invention includes: a structured-surface layer 2 and a supporting layer 5 bonded with the structured-surface layer 2.

The supporting layer 5 should be optically transparent, having proper structural strength and having temperature resistance and anti-aging properties.

The structured-surface layer 2 includes a palurality of upper prismatic protrusions or upper structured protrusions 3, such as forming a prism array C₁, C₂, C₃, C₄, etc., as shown in FIG. 1, formed on an upper portion of the structured-surface layer 2; and a plurality of lower protrusions or lower prismatic protrusions 4 formed on a bottom portion of the structured-surface layer 2.

Each upper prismatic protrusion 3 includes a pair of upper prism surfaces 3a, 3b defining an upper apex angle θ₁ between the two upper prism surfaces 3a, 3b. Each lower prismatic protrusion 4 includes a pair of lower prism surfaces 4a, 4b defining a lower apex angle θ₂. The upper apex angle θ₁ is preferably larger than the lower apex angle θ₂ (θ₁>θ₂). However, the size or the like of each angle θ1 or θ₂ is not limited in the present invention.

Each upper prismatic protrusion 3 has a base width W, which is larger than a base width W₁ of each lower protrusion 4 (W>W₁).

In practice, one upper protrusion 3 may correspond to plural lower protrusions 4 to satisfy the following formula:
W=xW₁,
wherein x may be an integral.

The upper protrusion 3 has a first height H₁ between its base (on Line DD*) and its apex 3c, while the lower protrusion 4 having a second height H₂ between the lower tip 4c and the base on Line DD*, preferably defining a relationship of: H₁>H₂.

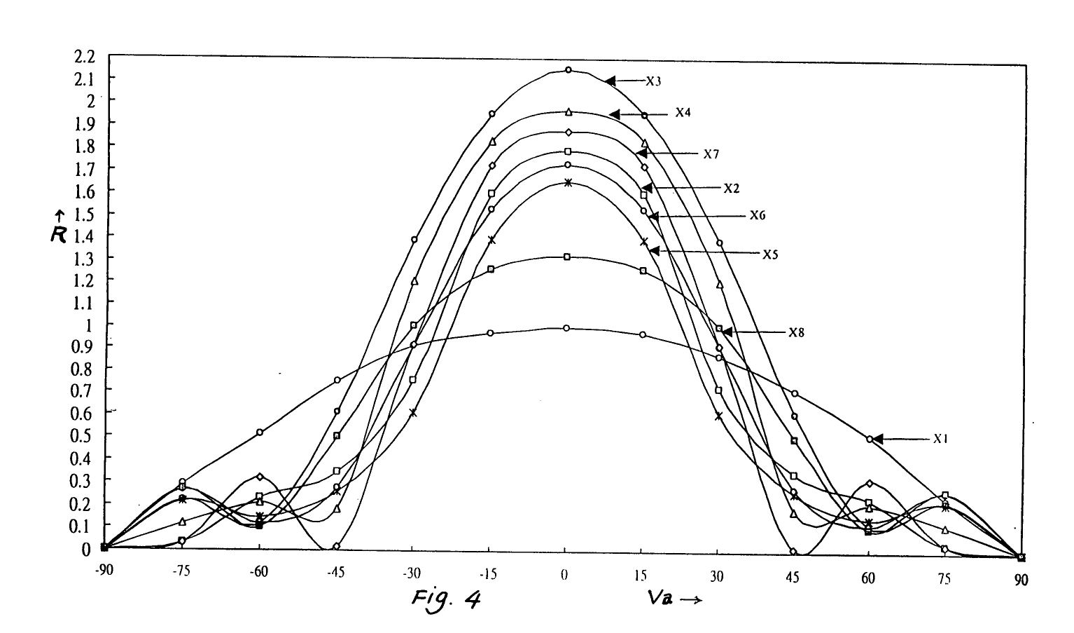

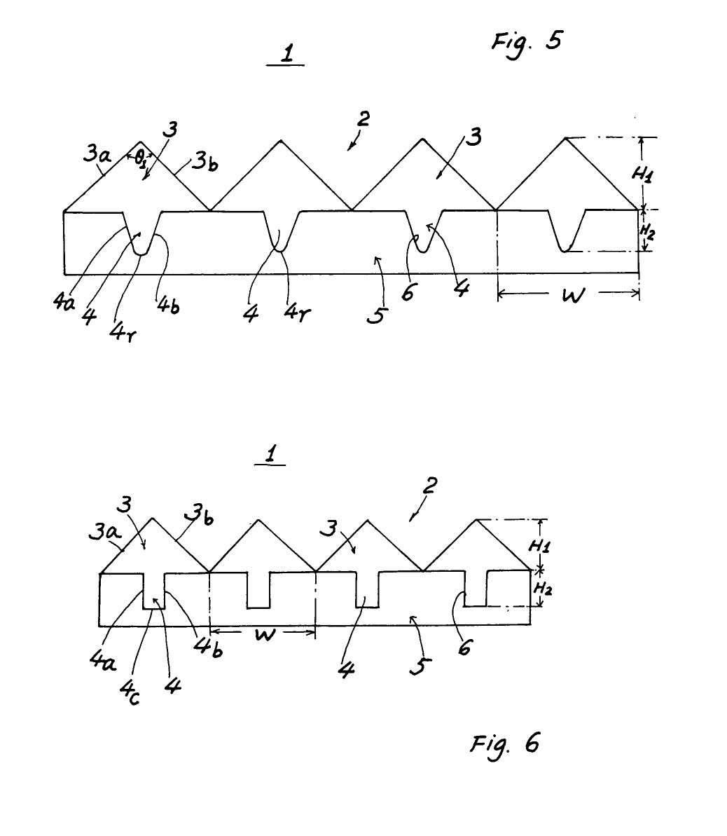

Other modifications may be made in accordance with the present invention and will be described in detail hereinafter, especially as shown in FIGS. 5˜13.

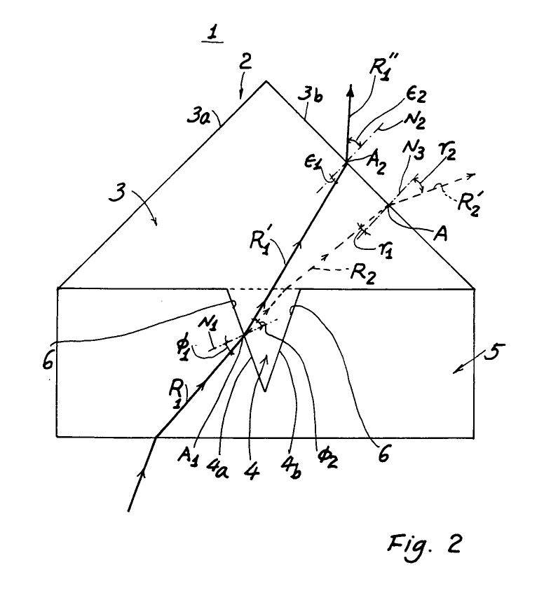

As shown in FIG. 2, an incoming light when projected into the optical film of the present invention, the incoming light entering the supporting layer 5, R₁, when passing the upper prismatic protrusion 3 of the upper layer 2 without passing through the lower prismatic protrusion 4 as taught by this invention, will be refracted to be a refracted light R₂ as shown in dotted line in FIG. 2. The refracted light R₂ when passing through an interface between the upper prismatic protrusion 3 and the air (dotted line shown) will be projected through a light path having an incidence angle γ₁ from the normal line N₃ (to point A) and having a refracted angle γ₂ from the normal line N₃ as outwardly refracted from the upper prism surface 3b (at point A) to be an outgoing light R′₂, which is greatly deviated from an on-axis of the upper prismatic protrusion, thereby causing light loss of the optical film. Thanks to the lower prismatic protrusion 4 as disclosed in the present invention, the incoming light R₁, when entering the lower protrusion 4 (at point A₁) through an incidence angle Φ₁ from the normal line N₁ (to point A₁), will be refracted through a refracted angle Φ₂ from the normal line N₁ to be a refracted light R′₁ (solid line shown) continuously passing through an interior in the upper protrusion 3 which is the same material of the lower protrusion 4 without forming any interface therebetween. The light R′₁ when passing through the upper prism surface 3b through an incidence angle ε₁ from the normal line N₂ (to point A₂) will be refracted outwardly at point A₂ through a refracted angle ε₂ from the normal line N₂ to be an outgoing light R₁″ leaving the prism surface 3b.

Such an outgoing refracted light R₁″ of this invention is approximating to an on-axis of the upper prismatic protrusion 3 to thereby increase the brightness of the optical film to be superior to that of the conventional upper prismatic structure (as shown in dotted line of FIG. 2) without forming a lower prismatic protrusion as taught by this invention.

Besides, since the lower prismatic protrusion 4 is stably engaged with a notch 6 as recessed in the supporting layer 5 to form an interlocking mechanism between the lower protrusion 4 and the supporting layer 5. Because the lower protrusion 4 is integrally formed with the upper prismatic protrusion 3 of the upper structured-surface layer 2, the upper structured-surface layer 2 will be firmly secured, bonded, interlocked with the lower supporting layer 5, thereby increasing the strength (including peel strength) of the films, and increasing the stiffness of the films to prevent from waving or deformation of the optical film when subjected to thermal stress.

Therefore, the lower protrusion 4 as interlocked with the supporting layer 5 will increase the optical properties and other mechanical or physical (or even chemical) properties of the optical films to thereby synergetically enhance multiple functions of the optical films to be superior to the conventional optical films.

The supporting layer 5 as used in the present invention should have a good transparency, proper structural strength and optimum temperature resistance or anti-aging or anti-scratching properties to be applied for optical products.

The supporting layer 5 may be made of the following most popularly used plastic or composite materials: Polyethylene Terephthalate (PET), polycarbonate (PC), styrene-acrylonitrile, cellulose acetate butyrate, cellulose acetate propionate, cellulose triacetate, polyether sulfone, polymethyl methacrylate, polyurethane, polyester, polyvinyl chloride, polystyrene, polyethylene naphthalate, copolymers, mixed naphthalene dicarboxylic acids, polycyclo-olefins and glass. The materials of supporting layer may also be selected from their mixtures or synthetic materials. The supporting layer may be multiplayer including suspending dispersed phase or continuous phase, not limited in this invention.

The materials for making or forming the upper structured-surface layer 2 of the present invention may comprise the following ingredients: diluters, oligomers, monomers, photoinitials and additives as cross linked.

A cross-linking polymer matrix having a refractive index of at least 1.50 and being durable when cured may be used in this invention. Such cross-linking polymers may include acrylate, methyl acrylate, bromides, alkyl phenyl acrylate (including: 4,6-dibromo-2-sec-butyl phenyl acrylate), methyl styrene monomer, brominated epoxy diacrylate, 2-phenoxyethyl acrylate hexa-functional aromatic urethane acrylate oligomer.

The diluter is provided to decrease the viscosity of the polymer to prevent from the occurrence of gas bubbles, thereby obtaining a perfect micro-structure. The diluters, as always used, may include mono-functional or di-functional monomer.

The photoinitial includes: organic peroxides, azo compounds, quinines, nitro compounds, acryl halides, hydrazones, mercapto compounds, imidazoles, chlorotriazines, benzoin, benzoin alkyl ethers, di-ketones, phenones, etc.

The upper structured-surfaced layer of optical film may be made of polymers having high refractive index such as made of methyl acrylate monomer, halide monomer and other monomers. Those free radical monomers and oligomers with high activity are used recently. The acrylic acid having high activity may also be widely used.

The synthetic polymer as used in this invention may include additive, such as: surfactant, anti-static electricity agent, etc. The surfactant such as fluorosurfactant may be provided to reduce the surface tension of the synthetic polymer, to improve the wetting property, and to enhance a smooth coating operation or coating quality.

For making the optical film of the present invention, the supporting layer 5 will be formed or recessed with a plurality of notches 6 in an upper surface or upper portion of the layer 5.

The upper structured-surface layer 2 is formed with a plurality of lower prismatic protrusions or lower protrusions 4 on a bottom portion of the structured-surface layer 2 to be engaged, bonded, fastened, secured with the notches 6 as recessed in the supporting layer 5.

If the upper structured-surface layer 2 is made of photo-curing or heat-curing adhesive resin material, the upper curable resinous layer may be directly coated on the lower supporting layer 5 to allow the adhesive fluidically flowing, penetrating and filling into the notches 6 of the supporting layer 5. After forming or molding the upper structured-surface layer 2 and after curing the resinous layer 2, the resin as filled in each notch 6 will also be cured to firmly bond the lower protrusion 4 of the upper layer 2 with the supporting layer 5.

However, the process or methods for making the optical films of the present invention are not limited.

The lower protrusions 4 of the upper structured-surface layer 2 may be pre-formed and then interlocked with the notches 6 formed in the lower supporting layer 5. The lower protrusion 4 is protruded downwardly from the upper protrusion 3 of the layer 2.

Or, the lower protrusions 4 of the upper structured-surface layer 2 may be formed in-situ during the forming process when coating the upper layer 2 on the lower supporting layer 5, not limited in the present invention.

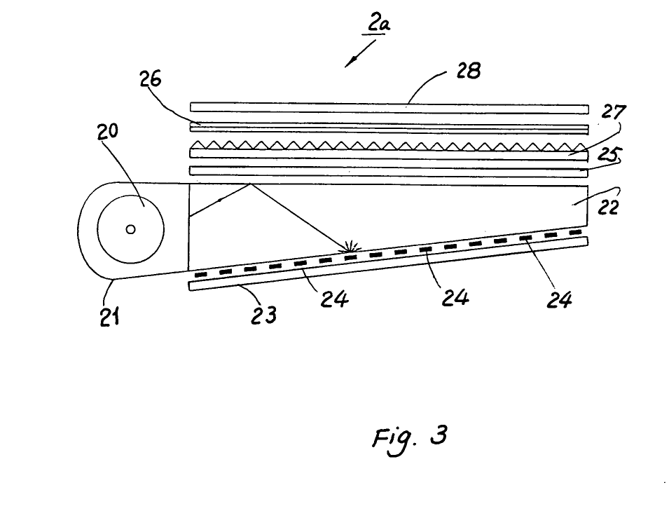

As shown in FIG. 3, a backlight module for optical simulation (with TracePro Software) may be applied for testing or evaluating the brightness of the optical films of the present invention.

The backlight module 2a as shown in FIG. 3 includes: a light source 20 having a reflector 21 secured with the light source 20, a light guide 22 juxtapositioned to the light source 20 for upwardly directing light as projected from the light source 20, a reflection sheet 23 having a plurality of scattering dots 24 formed on the sheet 23 and positioned beneath the light guide 22 for reflecting light upwardly through the guide 22 to prevent from light loss and to enhance the light utilization efficiency, a diffuser sheet 25 positioned above the light guide 22 for uniformizing luminescence, a pair of prism sheets 26, 27 stacked above the diffuser sheet 25 for collecting the diffused light for increasing the brightness, and a display unit 28 provided on top of the stacked prism sheets 26, 27.

The ribs of the upper prism sheet 26 may be perpendicular to that of the lower prism sheet 27.

The light source 20 is mounted on a side of the light guide 22 and may be selected from the group consisting of: cold cathode fluorescent lamp (CCFL), LED, MOLED, PLED or other planar light sources.

By using the backlight module 2a as shown in FIG. 3 and by means of TracPro software, the relative brightness for a plurality of optical films including the examples of this invention, as hereinafter described, will be primarily tested to obtain their simulated testing results which are shown in FIG. 4, in which the ordinate R indicates the ratio to on-axis brightness versus different viewing angles (degrees) Va on the abscissa.

### EXAMPLE FOR REFERENCE

First, the two stacked prism sheets 26, 27 are eliminated or removed from the module 2a as shown in FIG. 3. Then, a testing simulation result is obtained as shown on the Curve X₁ as shown in FIG. 4. Curve X₁ will serve as a “datum reference” for the subsequent tests.

### EXAMPLE OF CONTROL TEST

Then, two stacked prism sheets 26, 27 (without forming the lower protrusions 4 as taught by this invention) are installed to be the module 2a as shown in FIG. 3 in between the display unit 28 and the diffuser sheet 25. Another testing simulation data is obtained as shown on the Curve X₂ as shown in FIG. 4, in which the brightness is remarkably increased in comparison with the “datum reference” X₁ by the module without being implemented with the stacked prism sheets 26, 27. Namely, the brightness ratio (R=1.8) on Curve X₂ is greater than that (R=1) on Curve X₁ when viewed at zero viewing angle (Va=0).

The curve X2 will serve as a control test reference for checking the brightness of the optical films of the present invention, as hereinafter described in Examples 1˜10 with reference to FIGS. 1 and 5˜13.

### Example 1

Referring to the optical film 1 as shown in FIG. 1, several data having been given for the related elements or structures of the optical film of this example are shown as follows:
1. Upper apex (or dihedral) angle, θ₁ . . . 90°;
2. Lower apex angle, θ₂ . . . 20°;
3. Upper rib (or upper apex) height, H₁ . . . 25 μm;
4. Lower rib (or lower apex) height, H₂ . . . 5 μm;
5. Width of upper prism base W . . . 50 μm;
6. Thickness of supporting layer . . . 125 μm;

Two optical films 1 of the present invention are stacked and installed in between the display unit 28 and the diffuser sheet 25 of the module 2a as shown in FIG. 3. A simulated testing result is obtained and shown on Curve X₃ in FIG. 4, in which the brightness ratio (R=2.15) at zero viewing angle (Va=0) of this example (on curve X₃) is greater than that (R=1.8) of the control test on Curve X₂ (Example of Control Test).

It indicates the fact that the lower prismatic protrusions 4 formed on the bottom portion of the structured-surface layer 2 of the present invention will help refract light to approximate the on-axis of the prismatic structure of the upper layer 2 to thereby increase the brightness of the optical film.

Simultaneously, the lower protrusion 4 of the upper layer 2 is firmly interlocked with the notch 6 in the supporting layer 5, the stiffness and the bonding strength of the optical film of this invention have been increased with 162% and 198% respectively in comparison with that of the conventional optical film of Example of Control Test without forming the lower prismatic protrusions 4 as taught by the present invention.

Accordingly, multiple functions of the optical film as made by the present invention will be synergetically enhanced optionally, physically, mechanically, or even chemically.

### Example 2

The optical film 2 of the present invention is modified to be shown in FIG. 5, in which the upper apex angle is still maintained to be a right angle. However, the lower protrusion 4 is now modified to have a round tip 4r at the lower apex intersected by the two lower prism surfaces 4a, 4b.

Several data of this example are given as follows:
1. Upper apex angle, θ₁ . . . 90°;
2. Prism base width, W . . . 50 μm;
3. H₂/H₁=1/10; H₁+H₂=25 μm.

The methods for making the optical films of this example are not limited. The materials are made of photosensitive acrylic resin with high transparency, having a refractive index of 1.494.

Two stacked optical films of this example are installed in between the display unit 28 and the diffuser sheet 25 of the optical module 2a as shown in FIG. 3 for optical simulation test and a testing result is obtained as shown on Curve X₄ in FIG. 4, having a higher brightness ratio than that (X₂) as obtained by the Example of Control Test. The stiffness and bonding strength of the optical films of this example are respectively increased with 172% and 212% in comparison with that of the control test.

### Example 3

Example 2 is repeated, except that each lower protrusion 4 is modified to be a rectangular shape 4a, 4b, 4c (FIG. 6) having a length of 10 μm and a width of 5 μm.

The testing result of optical simulation is obtained and shown on Curve X₅ in FIG. 4. The stiffness and bonding strength of the optical films of this example are respectively increased with 202% and 272% in comparison with that of the control test as aforementioned.

### Example 4

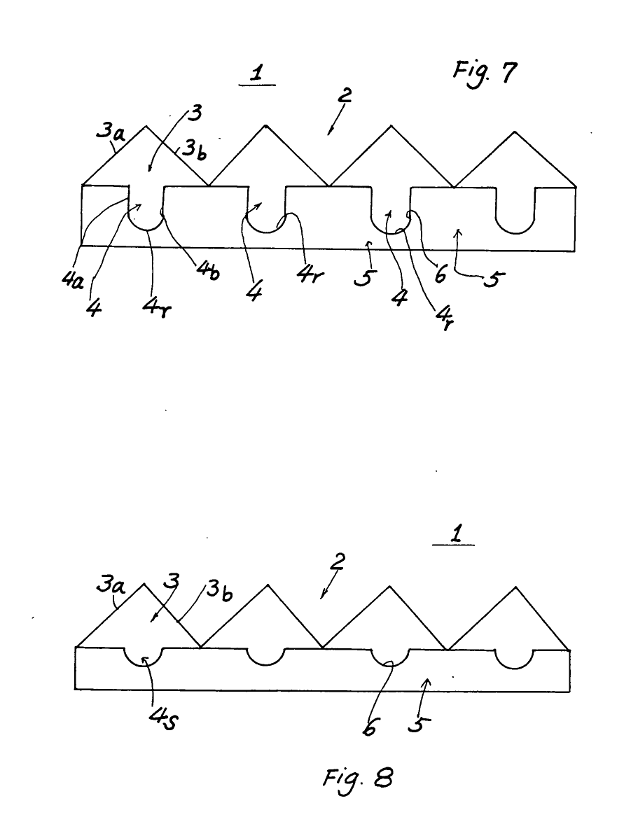

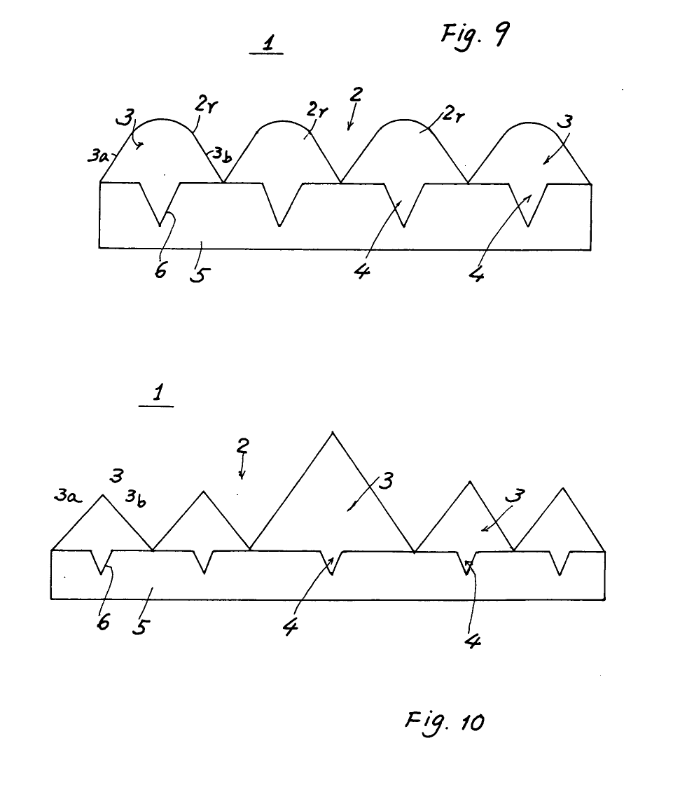

Example 3 is repeated, except that the bottom of each rectangular lower protrusion 4 (of Example 3) has been modified to be a round shape 4r (FIG. 7).

The testing result of optical simulation is obtained and shown on Curve X₆ in FIG. 4. The stiffness and bonding strength of the optical films of this example are increased with 190% and 257% respectively in comparison with the aforementioned control test.

### Example 5

Example 2 is repeated, excepted that the lower protrusion is modified to be a semi-circular or semi-cylindrical shape 4s as shown in FIG. 8. The testing result of optical simulation is shown on Curve X₇ in FIG. 4.

The stiffness and bonding strength of the optical films of this example are increased with 142% and 164% respectively in comparison with the aforementioned control test.

### Example 6

Example 1 is repeated, except that the upper prismatic protrusion has been modified to be a round tip 2r as shown in FIG. 9 and the heights H₁, H₂ have been modified to satisfy the following relationship:
H₂/H₁=1/10; H₁+H₂=25 μm.

The testing result is shown on Curve X₈ in FIG. 4, in which even the brightness is inferior to that as shown in the control test (Curve X₂). However, the stiffness and the bonding strength of the optical films of this example are still increased with 192% and 212% respectively in comparison with the aforementioned control test.

### Example 7

By varying the apex or rib heights of the prisms 3 as formed on an upper layer 2 above the supporting layer 5 for the optical films 1 of the present invention as shown in FIG. 10, the wet-out defects of the optical films will be overcome so as to enhance a better light concentration onto the display unit, thereby obtaining an optimum brightness and uniformized luminescence.

### Example 8

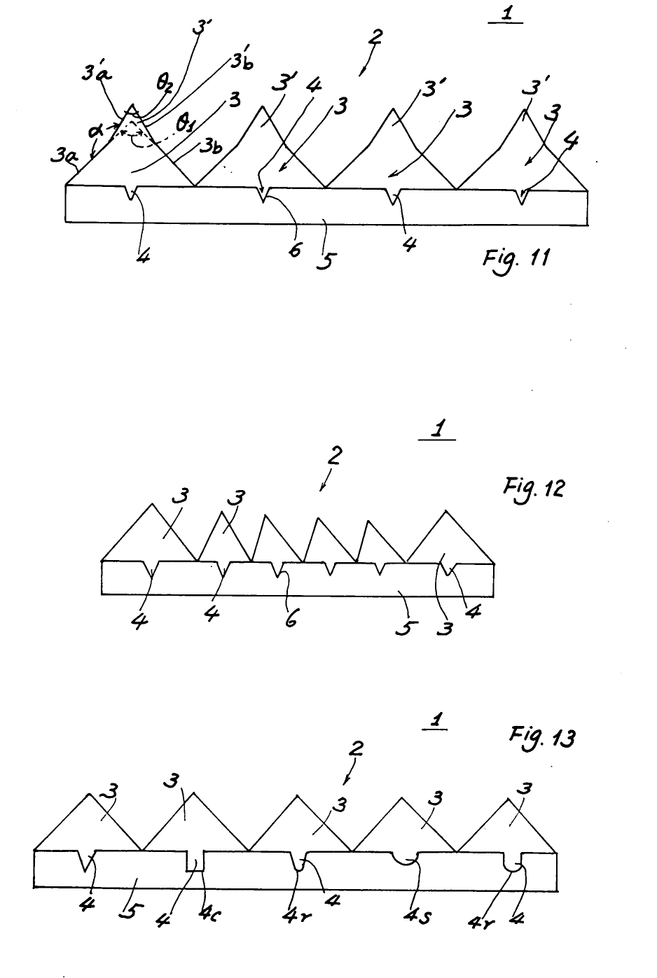

As shown in FIG. 11, each prism of the upper layer 2 as formed above the supporting layer 5 includes a first prism portion 3 having a pair of prism surfaces 3a, 3b tapered upwardly for defining a first apex angle θ₁, and a second prism portion 3′ integrally formed on the first prism portions 3 without forming any interface between the first prism portion 3 and second prism portion 3′, with the second prism portion 3′ including a pair of top prism surfaces 3′a, 3′b tapered upwardly for defining a second apex angel θ₂, which is generally smaller than θ₁(θ₁>θ₂).

Each prism surface 3a (or 3b) and each top prism surface 3′a (or 3′b) define an obtuse angle a therebetween. The uppermost tip of the second prism portion 3′ may also be modified to be a round tip, not limited in the present invention.

Each prism 3, 3′ has increased its tip height to effectively prevent from light loss, thereby increasing the overall brightness of the optical films.

### Example 9

As shown in FIG. 12, a plurality of prisms 3 are bonded above the supporting layer 5, with the prisms 3 having their optical axes oriented in different angles in order to obtain uniformized luminescence and to prevent from optical defects when viewed from a display unit disposed on the optical films.

### Example 10

As shown in FIG. 13, the lower protrusions 4 formed on a bottom portion of the upper structured-surface layer 2 are made with different shapes, forming another preferred embodiment of the present invention.

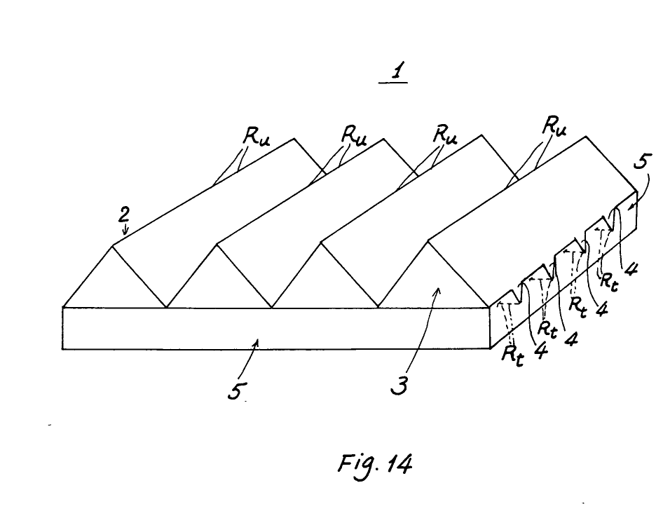

The lower protrusion 4 may have its ridge line Rt to be projectively perpendicular to an upper ridge line Ru of the upper prismatic protrusion 3 as shown in FIG. 14.

The ridges or ribs of the upper prismatic protrusion 3 may be parallel to, or perpendicular to or oriented with variable angles to the ridges or ribs of the lower prismatic protrusion 4 with one another. The ribs or ridges of the prisms may be presented as regular, irregular, random, linear, curving or any other shapes, not limited in this invention.

The lower protrusions 4 formed on the bottom portion of the upper protrusions and interlocked with the supporting layer 5 will increase the brightness of the optical films and also increase the stiffness, rigidity and bonding strength of the films of the present invention.

So, the present invention provides optical films for enhancing the multiple functions or properties of the films optically, physically, mechanically or even chemically.

Conclusively, the present invention may synergetically enhance the properties or functions of the optical films.

The present invention may be modified without departing from the spirit and scope of the present invention.

I claim:

1. An optical film comprising:
a structured-surface layer; and
a supporting layer bonded with said structured-surface layer;
said structured-surface layer including a plurality of upper structured protrusions formed on an upper portion of said structured-surface layer, and a plurality of lower protrusions formed on a bottom portion of said structured-surface layer and each said lower protrusion protruding downwardly from each said upper structured protrusion; and said supporting layer having a plurality of notches recessed in an upper portion of said supporting layer, each said lower protrusion of said structured-surface layer engaged and interlocked with each said notch in said supporting layer for firmly bonding said structured-surface layer with said supporting layer for forming an optical film having synergetically enhanced properties.

2. An optical film according to claim 1, wherein said upper structured protrusion is an upper prismatic protrusion.

3. An optical film according to claim 1, wherein said upper structured protrusion includes a round tip formed thereon.

4. An optical film according to claim 1, wherein said lower protrusion is a lower prismatic protrusion.

5. An optical film according to claim 4, wherein said lower prismatic protrusion includes a round tip formed thereon.

6. An optical film according to claim 1, wherein said lower protrusion is formed as a rectangular shape.

7. An optical film according to claim 6, wherein said lower protrusion of rectangular shape includes a round tip formed thereon.

8. An optical film according to claim 1, wherein said lower protrusion is formed as a semi-cylindrical or semi-circular shape.

9. An optical film according to claim 1, wherein said upper structured protrusions have their heights formed to be different from one another.

10. An optical film according to claim 2, wherein each said upper prismatic protrusion includes a first prism portion defining a first apex angle and bonded with said supporting layer, and a second prism portion integrally formed on said first prism portion and defining a second apex angle.

11. An optical film according to claim 1, wherein said upper structured protrusions have their optical axes formed to be oriented in different directions or angles with one another.

12. A process for making an optical film comprising the steps of:
A. Forming a supporting layer having a plurality of notches recessed in an upper portion of said supporting layer; and
B. Forming a structured-surface layer having a plurality of lower protrusions formed on a bottom portion of said structured-surface layer, and allowing each said lower protrusion to be engaged and interlocked with each said notch in said supporting layer for firmly bonding said structured-surface layer on said supporting layer.

13. An optical film according to claim 12, wherein said structured-surface layer is made of a curable adhesive resin and is coated on said supporting layer to allow said curable adhesive resin to be penetrated, filled and cured in each said notch to form each said lower protrusion in situ in each said notch for firmly bonding said structured-surface layer on said supporting layer.

14. An optical film according to claim 12, wherein said lower protrusion is a lower prismatic protrusion tapered downwardly.
